(19) United States
(12) Patent Application Publication
(10) Pub. No.: US 2005/0189024 A1
(43) Pub. Date: Sep. 1, 2005

(54) Non-return valve for vehicle ventilation

(75) Inventors: Thomas Dippel, Neuhemsbach (DE); Dirk Lauhoff, Kaiserslautern (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Electronics & Components GmbH & Co. KG

(21) Appl. No.: 10/975,854

(22) Filed: Oct. 28, 2004

(30) Foreign Application Priority Data
Oct. 28, 2003 (DE) 203 16 536.5

(51) Int. Cl. F16K 15/16

(52) U.S. Cl. 137/855

(57) ABSTRACT

A non-return valve (10) for ventilating a vehicle interior, having a frame (12), in which at least one outflow opening (14) is configured. The outflow opening (14) is surrounded by a valve seat (16) and at least one valve flap (18). The valve flap (18) can move between a closed position, in which the valve flap (18) contacts the valve seat (16) and closes the outflow opening (14), and the opened position in which the valve flap (18) releases the outflow opening (14). The valve flap (18) is made of an elastically springy material and is attached such that a return force is generated which urges the valve flap (18) toward the valve seat (16).

The present invention relates to a non-return valve, in particular, for ventilating a vehicle interior.

### BACKGROUND OF THE INVENTION

Typical non-return valves of this type have a frame, in which at least one outflow opening is configured, which is surrounded by a valve seat, and at least one valve flap, which can be moved between a closed position, in which it contacts the valve seat and closes the outflow opening, and an opened position, in which it releases the outflow opening.

A non-return valve of this type makes it possible to draw off the air that has been conveyed via a ventilation system into the vehicle interior. If no air flows out of the vehicle interior, the valve flap contacts the valve seat that is assigned to it, so that no penetration of humidity, exhaust gas, or dirt is permitted in the interior.

Usually, the valve flap is attached to the frame by a hinge. Furthermore, the valve seat is customarily positioned so as to be diagonal to the active direction of gravity, if the non-return valve is situated in its prescribed installation position, so that the valve flap contacts the valve seat due to gravity. As soon as a slight excess pressure exists in the interior of the vehicle, then the valve flap is lifted off from the valve seat, so that pressure equalization takes place.

The disadvantage in the known non-return valves lies in the fact that the prescribed installation position must be maintained so that the opening behavior of the valve flap, as determined by its design, is achieved. An orientation of the valve element that diverges from the prescribed installation position leads to the valve flap contacting the valve seat with greater or less force than stipulated.

The objective of the present invention lies in refining a non-return valve of the type cited above such that the non-return valve can be used in a multiplicity of devices.

### BRIEF DESCRIPTION OF THE INVENTION

For this purpose, according to the present invention, provision is made that the valve flap is made of an elastically springy material and is attached such that a return force is generated which urges the valve flap toward the valve seat. The present invention rests on the fundamental idea of biasing the valve flap in the closed position through its own elasticity. In this manner, the valve flap is returned to the closed position independent of gravity, so that the valve can be used in any installation position, for example, upside down. The valve flap itself is advantageously made of a rigid and light element, for example, a plastic foil that is resistant to bending. The smaller the weight of the valve flap, the less the influence of gravity on its opening behavior.

Advantageous embodiments of the present invention will become apparent from the subclaims.

### BRIEF DESCRIPTION OF THE DRAWINGS

The present invention is described below on the basis of a preferred embodiment, which is depicted in the attached drawings. In the latter:

FIG. 1 depicts a front view of a non-return valve according to the present invention;

FIG. 2 depicts a cutaway view along the line II-II in FIG. 1;

FIG. 3, in enlarged dimensions, depicts the segment designated in FIG. 2 as III.

### DETAILED DESCRIPTION OF THE INVENTION

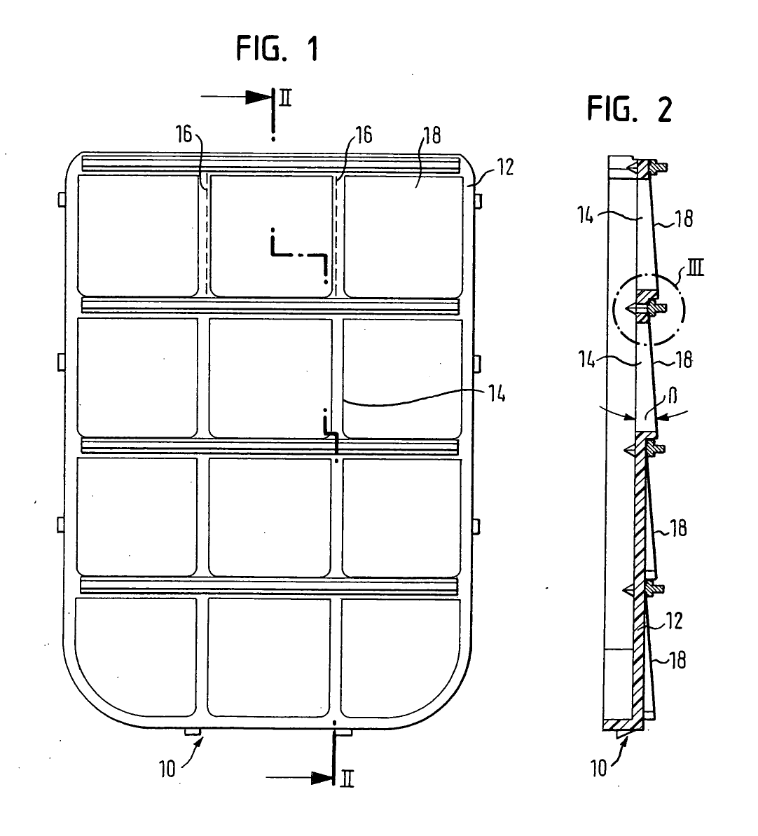

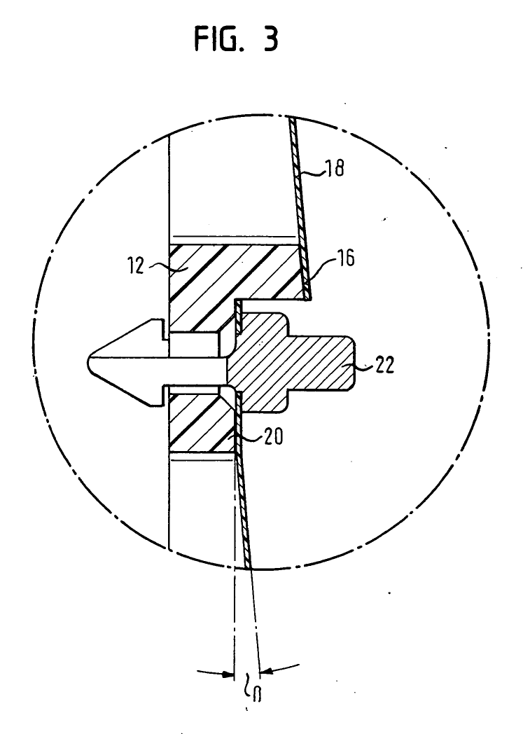

In the Figures, a non-return valve 10 is depicted, having a frame 12, which can be attached in an opening of a vehicle body. The frame is made of plastic and is configured as a lattice, so that a total of 12 outflow openings 14 are formed. At the edge of each outflow opening a valve seat 16 is provided, which, in the form of outflow openings 14 as depicted in FIG. 1, extends along three side walls of the outflow opening, namely along the two vertical sides and along the lower side. Valve seat 16 is arranged so as to be tilted with regard to the extension plane of frame 12, in each case, at an angle β (see FIGS. 2 and 3).

Assigned to each outflow opening 14 is a valve flap 18, which is made of a small thin plastic plate or a plastic foil. In any case, it is important that valve flap 18 have a certain rigidity of its own and, resulting therefrom, a certain bending elasticity.

Each valve flap 18 is attached to frame 10 in a mounting area 20, which is oriented parallel to the extension direction of frame 12. For attaching valve flap 18, a mounting clamp 22 is used, which extends through the valve flap into frame 12. As can be seen especially in FIG. 3, the valve flap is bent between the segment that is attached on mounting area 20 and therefore is oriented parallel to the extension direction of frame 12 and the segment that contacts the valve seat. This results from angle β between the orientation of the valve seat, on the one hand, and the orientation of mounting area 20, on the other hand. This bend, which is forced upon valve flap 18, leads to an elastic biasing, which elastically urges valve flap 18 toward valve seat 16. In this context, the system force of valve flap 18 on the valve seat 16 is advantageously greater than the weight of valve flap 18, so that the non-return valve can even be arranged so as to lie horizontally, i.e., upside down. The return forces then in opposition to the action of gravity are able reliably to urge valve flap 18 toward valve seat 16.

The valve flap can also be attached to the frame differently than depicted. Separate clamping strips or molded-on clamping strips can be used. It is also possible to bond the valve flap to the frame using a film hinge. In addition, molded-on fastening and supporting points or slots can be used. It is also possible to attach the valve flap to the frame by welds, glue, or screws. It is also possible to mold the valve flap directly onto the frame and to urge it toward the frame, for example, using additional strips, clamps, or the like. Finally, it is possible to achieve the elastic biasing of the valve flap through a bend in the valve flap in the mounting area, for example, by a bend above the mounting area or by a bead or hump arranged there. It is also possible to orient the valve seat parallel to the extension direction of the frame.

As an alternative to a planar valve seat, it is also possible to use a curved valve seat. In this way, the flap, when closed, only contacts one edge of the valve seat, before it is completely closed.

1. A non-return valve (10), in particular, for ventilating a vehicle interior, having a frame (12), in which at least one outflow opening (14) is configured, which is surrounded by a valve seat (16), and at least one valve flap (18), which can move between a closed position, in which it contacts said valve seat (16) and closes said outflow opening (14), and the opened position in which it releases said outflow opening (14), wherein said valve flap (18) is made of an elastically springy material and is attached such that a return force is generated which urges said valve flap (18) toward said valve seat (16).

2. The non-return valve as recited in claim 1, wherein an edge area of said valve flap (18) is attached to said frame (12) in a first orientation which differs from an orientation of said valve seat (16).

3. The non-return valve as recited in claim 1, wherein an edge area of said valve flap (18) is deformed on said frame (12) so that said return force is generated.

4. The non-return valve as recited in claim 1, wherein on said frame a pressure element is attached which biases said valve flap (18) such that it is urged toward said valve seat (16).

5. The non-return valve as recited in claim 1, wherein said return force generated by an elastic bias of said valve flap (18) is greater than a weight of said valve flap (18).
